(19) United States
(12) Patent Application Publication
(10) Pub. No.: US 2002/0142733 A1
(43) Pub. Date: Oct. 3, 2002

(54) Transmitter-receiver circuit

(76) Inventor: Kenji Nishinakagawa, Yamatotakada-shi (JP)

Correspondence Address: BIRCH STEWART KOLASCH & BIRCH, PO BOX 747, FALLS CHURCH, VA, 22040-0747, US

(21) Appl. No.: 10/078,709

(22) Filed: Feb. 21, 2002

(30) Foreign Application Priority Data
Feb. 21, 2001 (JP) 2001-45657

(51) Int. Cl. H04B 1/40

(52) U.S. Cl. 455/84; 455/78

(57) ABSTRACT

A transmitter-receiver circuit is provided with a band pass filter which extracts a desired frequency component from a receiving signal and a low pass filter which removes an unnecessary frequency component from a transmitting signal. In the transmitter-receiver circuit, the band pass filter and the low pass filter are formed in the same chip so that a variation of impedance elements becomes the same, and a frequency adjustment signal, which is generated in a digital circuit, to adjust band pass characteristics of the band pass filter is commonly used for the adjustment of a variation of the band pass filter. Therefore, by sharing the configuration for detection and adjustment of the variation, it is possible to reduce size of the circuit and make a cut-off frequency of the low pass filter constant, thereby generating a stable transmitting signal.

### FIELD OF THE INVENTION

The present invention relates to a transmitter-receiver circuit which suitably becomes operative in a device such as a radio communication device for Bluetooth™ (Association of Radio Industries and Businesses STD-T66.1).

### BACKGROUND OF THE INVENTION

FIG. 6 is a block diagram illustrating a typical conventional transmitter-receiver circuit 1. The transmitter-receiver circuit 1 chiefly has a receiver section, a transmitter section, and a digital circuit 10. The receiver section is provided with a radio frequency amplifier 2, a band pass filter 3, a demodulation circuit 4, and an analog/digital conversion circuit 5. The transmitter section is provided with a digital/analog conversion circuit 6, a low pass filter 7, a modulation circuit 8, and a power amplifier 9. The digital circuit 10 controls the transmitter section and the receiver section and performs a baseband signal processing.

Out of a receiving signal from the radio frequency amplifier 2, a frequency component to be received is extracted by the band pass filter 3. The resulting signal is analog-demodulated in the demodulation circuit 4, and then converted to a digital signal in the analog/digital conversion circuit 5 before it is inputted to the digital circuit 10 to perform baseband processing. The transmitting signal of a baseband component from the digital circuit 10 is converted to an analog signal in the digital/analog conversion circuit 6 and is given to the modulation circuit 8 through the low pass filter 7. The transmitting signal generated in the modulation circuit 8 is transmitted through the power amplifier 9.

In the transmitter-receiver circuit 1 which has the configuration as described above, the band pass filter 3 in the receiver section is a high-accurate filter with a pass band width of 1 MHz with respect to the center frequency of the pass band at 2 MHz, which is adapted to obtain a large attenuation at the frequency which is 1 MHz away from the center frequency. Also, in the band path filter 3 and the demodulation circuit 4, a frequency adjustment signal from the digital circuit 10 adjusts a variation of band pass characteristics caused by an absolute variation of impedance elements making up the filter.

More specifically, as shown in FIG. 7, the demodulation circuit 4 is configured to be an FM demodulation circuit in which a phase shifter 11, which has partially the same circuit configuration as the band pass filter 3, and a multiplier 12 are used, where the phase shifter 11 is required to generate a signal which is precisely 90° off-phase with respect to the receiving signal. Thus, by the input of a 2 MHz reference signal which is substantially equal in frequency to the receiving signal, a variation of the phase shifter 11 can be taken out from the demodulation circuit 4 in the form of a variation of the output voltage. The digital circuit 10 then uses this variation for the feedback to the band pass filter 3 and the phase shifter 11 inside of the demodulation circuit 4 as the frequency adjustment signal, so as to accurately adjust the variation of the band pass characteristics caused by the absolute variation of the impedance elements.

Note that, in the example shown in FIG. 6, the reference signal is inputted to the band pass filter 3; however, the direct input of the reference signal to the demodulation circuit 4 also makes it possible to detect the variation in the same manner.

On the other hand, in the transmitter section, the low pass filter 7 is used to eliminate a frequency component in the vicinity of a clock signal of the digital/analog conversion circuit 6 and to pass a direct current component. Also in the low pass filter 7, if a frequency adjustment function similar to that of the band pass filter 3 and the demodulation circuit 4 is provided, another pair of reference signal source and a circuit for detecting the offset will be needed. Moreover, a circuit for generating a frequency adjustment signal to adjust the offset will be needed in the digital circuit 10. Accordingly, the size of the circuit of the transmitter section becomes large, which in turn increases the circuit size of the digital circuit 10.

Therefore, conventionally in the low pass filter 7 which is provided in the transmitter section as described above, a high cut-off frequency is set so as to meet a designed value even in the worst condition of the variation, without providing the frequency adjustment function for the circuit elements such as the band pass filter 3 in the receiver section.

Here, as shown in FIG. 8, the low pass filter 7 has an RC integration circuit which is made up of resistors R1 and R2 and capacitors C1 and C2, and an output circuit which is made up of a transistor (tr) and a constant current source 13. A cut-off frequency (fc) is found by the following Equation:

$$fc = \frac{1}{2 π} \cdot \frac{1}{\sqrt{C 1 \cdot C 2 \cdot R 1 \cdot R 2}} \qquad ( 1 )$$

Therefore, the absolute variation of impedance elements of the resistors R1 and R2 and the capacitors C1 and C2 vary the frequency characteristics. The absolute variation of these impedance elements is on the order of ±20%. For example, when a low pass filter having a 1 MHz cut-off frequency is designed, its variation comes to vary the cut-off frequency (fc) in the range of from 0.69 MHz to 1.56 MHz. Thus, in order to maintain performance, it is required to take into consideration this variation and set a high cut-off frequency under normal conditions so as to prevent the frequency from falling below 1 MHz even under the worst condition as described before. This causes a problem that it is impossible to realize a low pass filter with high accuracy.

### SUMMARY OF THE INVENTION

It is an object of the present invention to provide a transmitter-receiver circuit in which a cut-off frequency of a low pass filter of a transmitter section can be set with high accuracy, without increasing circuit size.

To achieve the object, a transmitter-receiver circuit comprises: a band pass filter which extracts a desired frequency component from a receiving signal; a low pass filter which removes an unnecessary frequency component from a transmitting signal; and adjustment signal generating means, provided in association with the band pass filter, for generating a frequency adjustment signal, so as to adjust band pass characteristics of the band pass filter, wherein: the band pass filter has a first adjustment means for adjusting the band pass characteristics in response to the frequency adjustment signal and, the low pass filter is provided in a chip in which the band pass filter is provided, and has second adjustment means for adjusting a cut-off frequency of the low pass filter in response to the frequency adjustment signal which is generated in the adjustment signal generating means.

According to the configuration, the frequency adjustment signal, which is generated by the adjustment signal generating means, to adjust the variation of frequency characteristics of the band pass filter is directly used for the adjustment of the cut-off frequency of the low pass filter which is provided in the same semiconductor integrated circuit as that of the band pass filter.

Therefore, it is possible to make the low pass filter having a constant cut-off frequency regardless of the variation of impedance elements of the low pass filter, thereby generating a stable transmitting signal. Further, even though the variation is adjusted this way to accurately set the cut-off frequency, the configuration which detects and adjust the variation is able to share the adjustment signal generating means for detecting and adjusting the variations of the band pass filter, thereby reducing size of the whole circuit.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating a transmitter-receiver circuit of an embodiment of the present invention.

FIG. 2 is a block diagram illustrating an example of a configuration of a low pass filter of the transmitter-receiver circuit.

FIG. 3 is an electrical circuit diagram illustrating an example of a configuration of variable resistors in the low pass filter of FIG. 2.

FIG. 4 is a block diagram illustrating another example of a configuration of the low pass filter.

FIG. 5 is an electrical circuit diagram illustrating an example of a configuration of variable resistors in the low pass filter of FIG. 4.

FIG. 6 is a block diagram illustrating a typical conventional transmitter-receiver circuit.

FIG. 7 is a drawing explaining a configuration of a demodulation circuit of the transmitter-receiver circuit shown in FIG. 6.

FIG. 8 is an electrical circuit diagram illustrating a conventional low pass filter.

### DESCRIPTION OF THE EMBODIMENTS

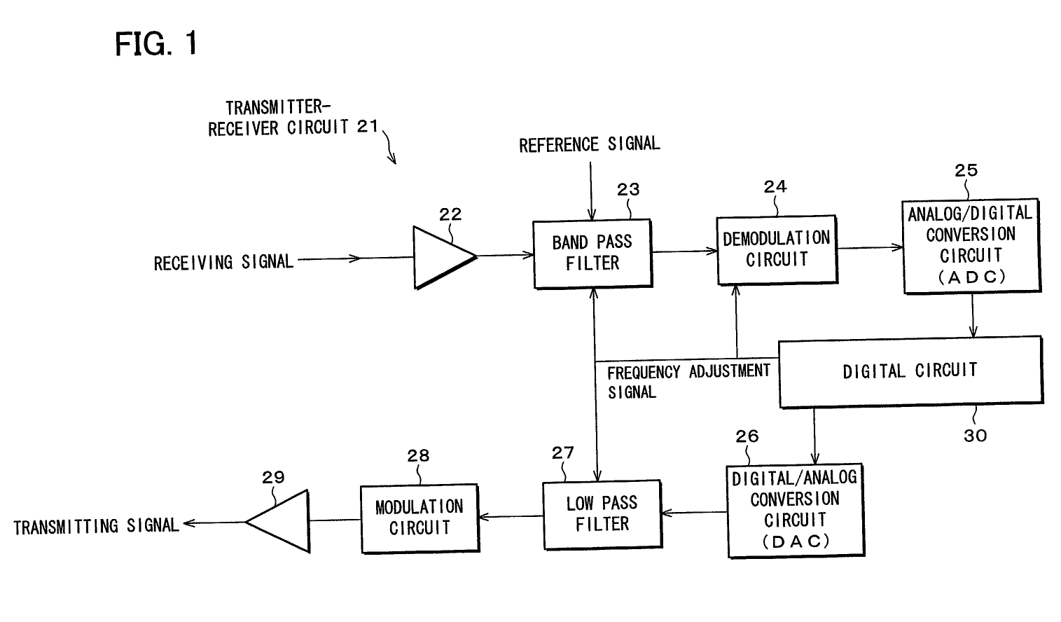

Referring to FIG. 1 through FIG. 5, an embodiment of the present invention is described as follows.

FIG. 1 is a block diagram illustrating a transmitter-receiver circuit 21 of an embodiment of the present invention. The transmitter-receiver circuit 21 chiefly includes a receiver section, a transmitter section, and a digital circuit 30. The receiver section is provided with a radio frequency amplifier 22, a band pass filter 23, a demodulation circuit 24, and an analog/digital conversion circuit 25. The transmitter section is provided with a digital/analog conversion circuit 26, a low pass filter 27, a modulation circuit 28, and a power amplifier 29. The digital circuit 30 controls the transmitter section and the receiver section and performs baseband signal processing. The radio frequency signal transmitted and received in the transmitter-receiver circuit 21 is a signal in 2.4 GHz band, which is created by a spread spectrum technology by frequency hopping and the transmitter-receiver circuit 21 is realized as a transmitter-receiver circuit for the Bluetooth™ technology.

Out of a receiving signal from the radio frequency amplifier 22, a frequency component to be received is extracted by the band pass filter 23. The resulting signal is analog-demodulated in the demodulation circuit 24, and then converted to a digital signal in the analog/digital conversion circuit 25 before it is inputted to the digital circuit 30 to perform baseband processing. The transmitting signal of a baseband component from the digital circuit 30 is converted to an analog signal in the digital/analog conversion circuit 26 and is given to the modulation circuit 28 through the low pass filter 27. The transmitting signal generated in the modulation circuit 28 is transmitted through the power amplifier 29.

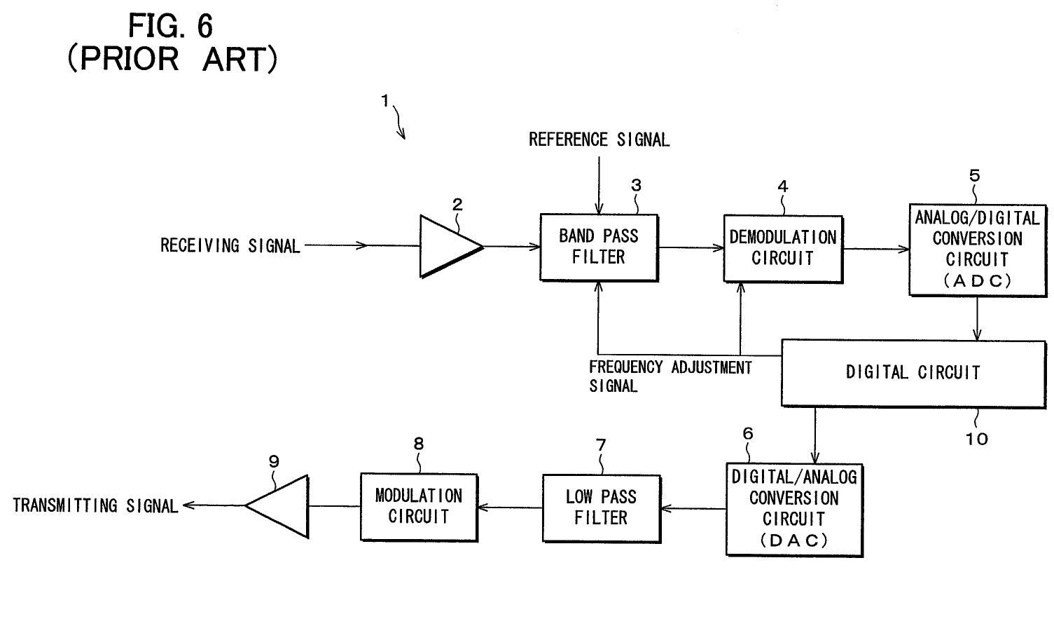

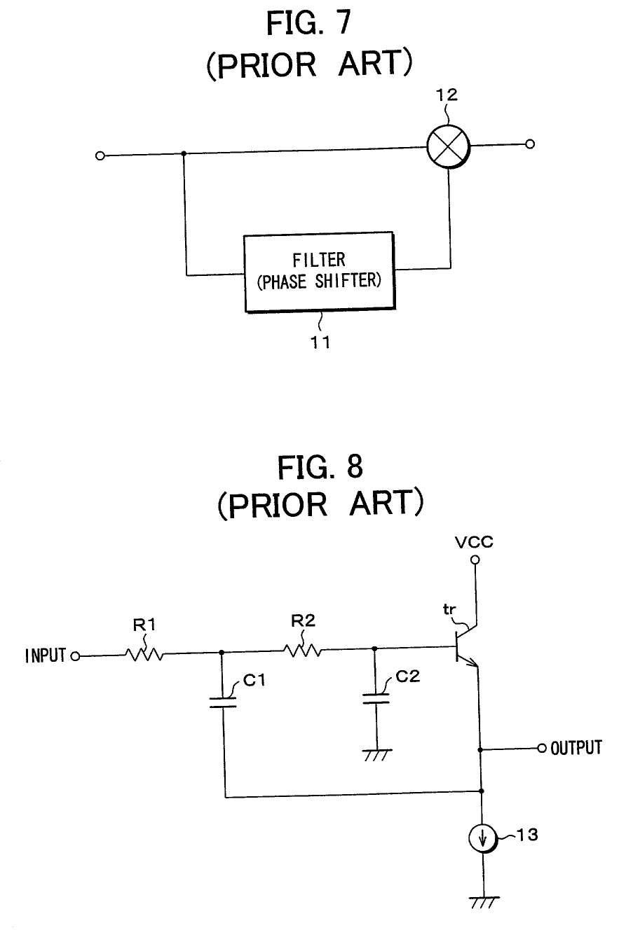

The band pass filter 23 in the receiver section is a high-accurate filter with a wide pass band width of 1 MHz with respect to the center frequency of the pass band at 2 MHz, which is adapted to obtain a large attenuation at the frequency which is 1 MHz away from the center frequency. As is the case with the transmitter-receiver circuit 1 as shown in FIG. 6, a frequency adjustment signal from the digital circuit 30 adjusts a variation of band pass characteristics caused by an absolute variation of impedance elements making up the filter. In the example of FIG. 1, the reference signal for detecting a variation is inputted to the band pass filter 23; however, the direct input of the reference signal to the demodulation circuit 24 also makes it possible to detect the variation in the same manner.

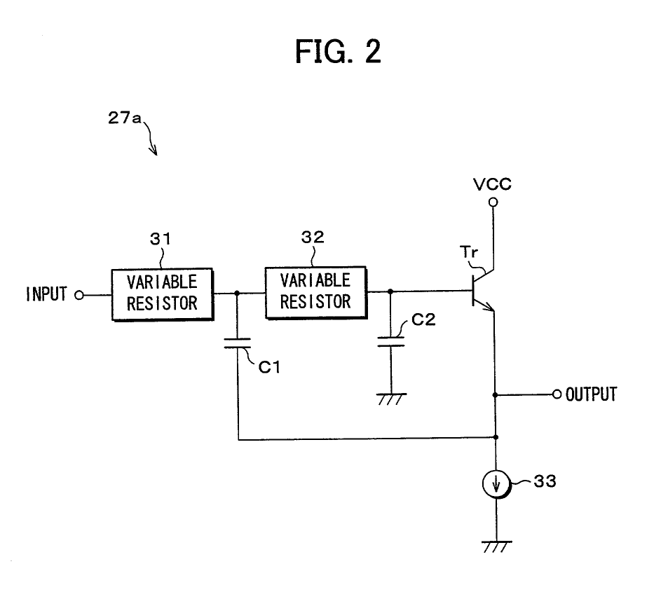

What is significant in the present embodiment is that the band pass filter 23 and low pass filter 27 are formed in the same chip, and as shown in FIG. 2 through FIG. 5 to be described below, the low pass filter 27 is configured so as to adjust the cut-off frequency. Further, the frequency adjustment signal generated in the digital circuit 30 to adjust a variation of frequency characteristics of the band pass filter 23 is directly used for adjusting the cut-off frequency of the low pass filter 27 which is provided in the same semiconductor circuit.

That is, since the impedance elements which make up the low pass filter 27 of the receiver section are provided in the same semiconductor integrated circuit as that of the transmitter section, a variance which may be generated during the production process, such as an offset of a mask or a change in etching conditions occurs equally. This phenomenon is exploited in the present embodiment. For example, when a resistance value of a resistor which makes up the band pass filter 23 becomes larger by 20% than a standard value, a resistance value of a resistor which makes up the low pass filter 27 also becomes larger by 20% than the standard value. Therefore, adjustment of the low pass filter 27 does not require detection of absolute variation of the impedance elements of the low pass filter 27. Instead, the frequency adjustment signal to adjust a variation of the band pass filter 23 can be used for the adjustment of the low pass filter 27.

FIG. 2 is a block diagram of a low pass filter 27a, illustrating an example of a configuration of the low pass filter 27. The low pass filter 27a has an RC integration circuit which is made up of variable resistors 31 and 32 and capacitors C1 and C2, and an output circuit which is made up of a transistor (Tr) and a constant current source 33. The cut-off frequency (fc) of the low pass filter 27a can be found by Equation (1), where R1 and R2 are resistance values of the variable resistors 31 and 32, respectively.

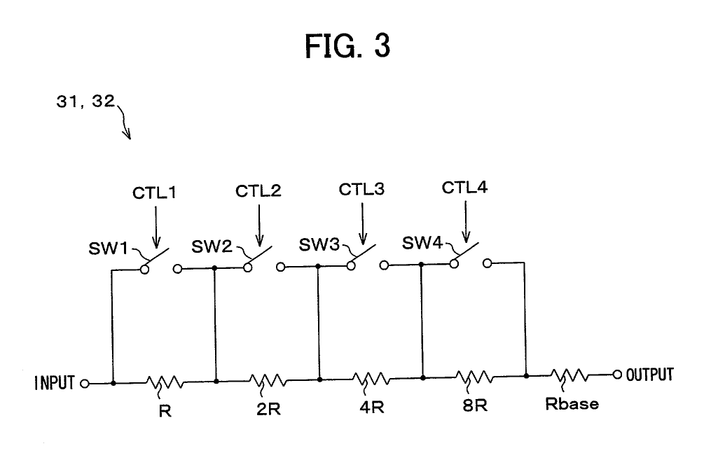

FIG. 3 is an electrical circuit diagram illustrating an example of a configuration of the variable resistors 31 and 32. The variable resistors 31 and 32 are provided with four resistors R, 2R, 4R and 8R, and a base resistor Rbase having a minimum resistance value, which are connected in series between input and output terminals. The variable resistors 31 and 32 are also provided with switches SW1 to SW4 which can short the respective terminals of the resistors R, 2R, 4R and 8R. The resistance value of the resistor R is used as a reference to set resistance values of the resistors 2R, 4R and 8R, which are 2 times, 4 times, and 8 times the reference, respectively.

The switches SW1 to SW4 are ON/OFF controlled, independently, by frequency adjustment signals CTL1 to CTL4 from the digital circuit 30. For example, the resistance value of the variable resistors 31 and 32 becomes 15R+Rbase (Ω) when all of the switches SW1 to SW4 are switched off, and it becomes 7R+Rbase (Ω) when only the switch SW4 is switched on. Thus, by adjusting the frequency adjustment signals CTL1 to CTL4 which correspond to the switches SW1 to SW4 from the lower bits, the resistance value can be increased by R (Ω) at 15 levels in the range of from R (Ω) to 15R (Ω). The resistance values of the resistor Rbase and the resistor R as a reference are decided so that an absolute variation of ±20% of the variable resistors 31 and 32 and capacitors C1 and C2 can be accommodated in the range from R (Ω) to 15 R (Ω), and a variance of cut-off frequency can be adjusted.

The above example is for the case where the frequency adjustment signals are 4 bit signals CTL1 to CTL4, and two pairs of variable resistors 31 and 32 having the same configuration are controlled in conjunction with each other (by the same frequency adjustment signals CTL1 to CTL4), where R1 is equal to R2. However, the number of bits may be 5 or above, or 3 or below. Further, either one of the variable resistors 31 and 32 may be adjusted, or the variable resistors 31 and 32 may be adjusted by different numbers of bits.

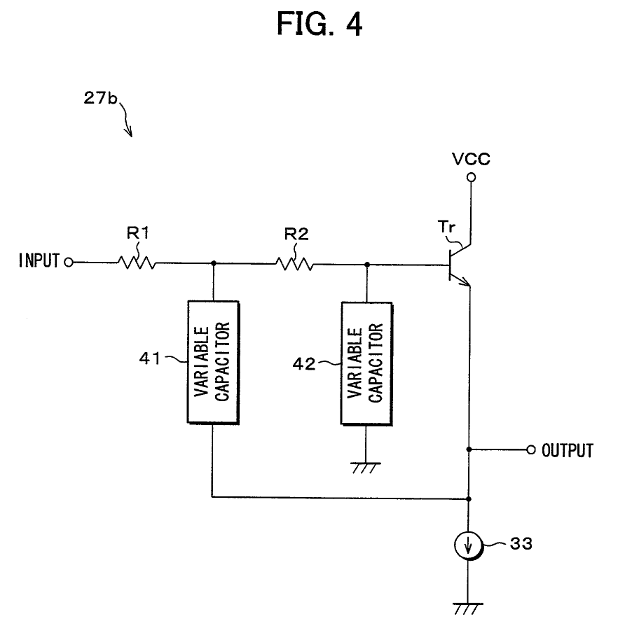

Meanwhile, FIG. 4 is a block diagram of a low pass filter 27b illustrating another example of a configuration of the low pass filter 27. The low pass filter 27b has an RC integration circuit which is made up of resistors R1 and R2 and variable capacitors 41 and 42, and an output circuit which is made up of a transistor (Tr) and a constant current source 33. The cut-off frequency (fc) of the low pass filter 27b can be found by Equation (1), where C1 and C2 are capacitances of the variable capacitors 41 and 42, respectively.

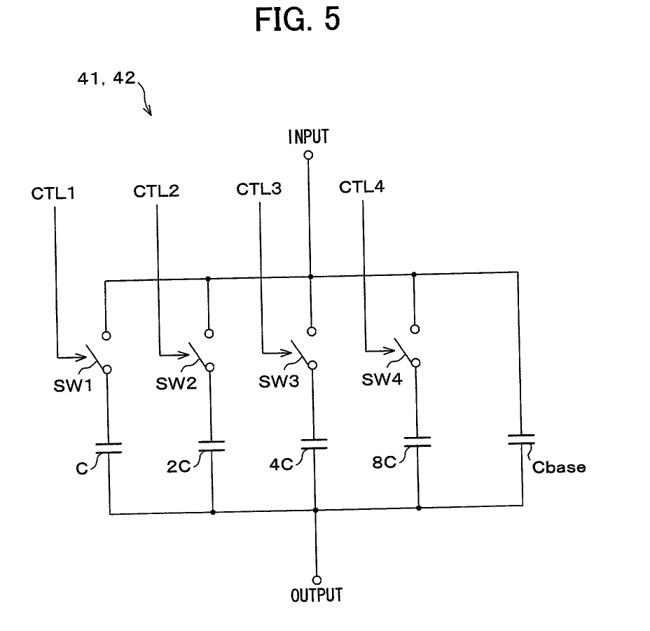

FIG. 5 is an electrical circuit diagram illustrating an example of a configuration of the variable capacitors 41 and 42. The idea of the variable capacitors 41 and 42 is similar to that of the variable resistors 31 and 32 as described before. The variable capacitors 41 and 42 are provided with four capacitors C, 2C, 4C and 8C, and a base capacitor Cbase having a minimum capacitance, which are connected in parallel to each other between input and output terminals. The variable capacitors 41 and 42 are also provided with switches SW1 to SW4 by which the capacitors C, 2C, 4C, and 8C can be independently connected or disconnected between the input and output terminals. The capacitance of the capacitor C is used as a reference to set capacitances of the capacitors 2C, 4C and 8C, which are 2 times, 4 times, and 8 times the capacitance of the capacitor C, respectively.

The switches SW1 to SW4 are ON/OFF controlled, independently, by frequency adjustment signals CTL1 to CTL4. For example, the capacitance of the variable capacitors 41 and 42 becomes 15C+Cbase (F) when all of the switches SW1 to SW4 are switched on, and it becomes 7C+Cbase (F) when only the switch SW4 is switched off. Thus, by adjusting the frequency adjustment signals CTL1 to CTL4 which correspond to the switches SW1 to SW4 from the lower bits, the capacitance can be increased by C (F) at 15 levels in the range of from C (F) to 15C (F). The capacitances of the capacitor Cbase and the capacitor C as a reference are decided so that an absolute variation of ±20% of the variable capacitors 41 and 42 and the resistors R1 and R2 can be accommodated in the range from C (F) to 15C (F), and a variance of cut-off frequency can be adjusted.

In such way, in the present embodiment, it is possible to make the low pass filter 27 having a constant cut-off frequency regardless of the variation of the impedance elements of the low pass filter 27 in the transmitter section, thereby generating a stable transmitting signal. Further, even though the variation is adjusted this way to accurately set the cut-off frequency, the configuration for detecting and adjusting the variation remains in a single chip. Thus, the configuration can be shared in the digital circuit 30 for detecting and adjusting the variations of the band pass filter 23 and the demodulation circuit 24, thereby reducing size of the whole circuit.

Further, the low pass filters 27a and 27b are provided with a plurality of impedance elements (the resistors R, 2R, 4R, 8R and Rbase in the low pass filter 27a, the capacitors C, 2C, 4C, 8C, and Cbase in the low pass filter 27b) which are selectively operated by the switches SW1 to SW4 in response to the frequency adjustment signals CTL1 to CTL4. Thus, by suitably selecting a constant for the reference impedance element (the resistors R and Rbase in the low pass filter 27a, the capacitors C and Cbase in the low pass filter 27b), any band pass characteristic and cut-off frequency can be set individually even though the frequency adjustment signals and the band pass filter 23 are shared.

As described above, a transmitter-receiver circuit comprises: a band pass filter which extracts a desired frequency component from a receiving signal; a low pass filter which removes an unnecessary frequency component from a transmitting signal; and adjustment signal generating means, provided in association with the band pass filter, for generating a frequency adjustment signal, so as to adjust band pass characteristics of the band pass filter, wherein: the band pass filter has a first adjustment means for adjusting the band pass characteristics in response to the frequency adjustment signal and, the low pass filter is provided in a chip in which the band pass filter is provided, and has second adjustment means for adjusting a cut-off frequency of the low pass filter in response to the frequency adjustment signal which is generated in the adjustment signal generating means.

According to the configuration, the frequency adjustment signal, which is generated by the adjustment signal generating means, to adjust the variation of frequency characteristics of the band pass filter is directly used for the adjustment of the cut-off frequency of the low pass filter which is provided in the same semiconductor integrated circuit as that of the band pass filter.

Therefore, it is possible to make the low pass filter having a constant cut-off frequency regardless of the variation of impedance elements of the low pass filter, thereby generating a stable transmitting signal. Further, even though the variation is adjusted this way to accurately set the cut-off frequency, the configuration which detects and adjust the variation is able to share the adjustment signal generating means for detecting and adjusting the variations of the band pass filter, thereby reducing size of the whole circuit.

In the transmitter-receiver circuit, it is preferable that both the first adjustment means and the second adjustment means comprises: impedance elements, having equivalent functions, which are in some part divided into a plurality of impedance elements, and switching elements which are switched under the control of the frequency adjustment signal, so as to selectively operate the impedance elements.

According to the configuration, by suitably selecting a constant for the reference impedance element in the first and second adjustment means, any band pass characteristic and cut-off frequency can be set individually even though the frequency adjustment signal is shared. Especially, the fact that the impedance elements are resistors makes it possible to reduce the area of the chip as compared to the configuration that the capacitance of the capacitors is changed.

Further, in the transmitter-receiver circuit, it is preferable that the radio frequency signal transmitted and received is in a 2.4 GHz band and is the signal which uses a spread spectrum technology by frequency hopping. This makes it possible to realize a transmitter-receiver circuit for the Bluetooth™ technology.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A transmitter-receiver circuit comprising:
a band pass filter which extracts a desired frequency component from a receiving signal;
a low pass filter which removes an unnecessary frequency component from a transmitting signal; and
adjustment signal generating means, provided in association with the band pass filter, for generating a frequency adjustment signal, so as to adjust band pass characteristics of the band pass filter,
wherein:
the band pass filter has a first adjustment means for adjusting the band pass characteristics in response to the frequency adjustment signal and,
the low pass filter is provided in a chip in which the band pass filter is provided, and has second adjustment means for adjusting a cut-off frequency of the low pass filter in response to the frequency adjustment signal which is generated in the adjustment signal generating means.

2. The transmitter-receiver circuit according to claim 1, wherein a radio frequency signal transmitted and received is in a 2.4 GHz band and is a signal which uses a spread spectrum technology by frequency hopping.

3. The transmitter-receiver circuit according to claim 1, wherein both the first adjustment means and the second adjustment means comprises:
a plurality of impedance elements having equivalent functions; and
switching elements which are switched under control of the frequency adjustment signal, so as to selectively operate the impedance elements.

4. The transmitter-receiver circuit according to claim 3, wherein a radio frequency signal transmitted and received is in a 2.4 GHz band and is a signal which uses a spread spectrum technology by frequency hopping.

5. The transmitter-receiver circuit according to claim 3, wherein the impedance elements are resistances.

6. The transmitter-receiver circuit according to claim 5, wherein the resistances are connected in series between an input terminal and an output terminal, and the switching elements short and open terminals of the respective resistors.

7. The transmitter-receiver circuit according to claim 5, wherein a radio frequency signal transmitted and received is in a 2.4 GHz band and is a signal which uses a spread spectrum technology by frequency hopping.

8. The transmitter-receiver circuit according to claim 3, wherein the impedance elements are capacitors.

9. The transmitter-receiver circuit according to claim 4, wherein the capacitors are connected in parallel between an input terminal and an output terminal, and the switching elements are connected in series with the respective capacitors so as to connect and disconnect the respective capacitors between the input terminal and the output terminal.
